(19) United States
(12) Patent Application Publication
(10) Pub. No.: US 2015/0110018 A1
(43) Pub. Date: Apr. 23, 2015

(54) Wireless Multi-Flow Communications in the Uplink

(71) Applicant: Nokia Solutions and Networks Oy, Espoo (FI)

(72) Inventors: Claudio Rosa, Randers (DK); Chunli Wu, Beijing (CN)

(21) Appl. No.: 14/384,433

(22) PCT Filed: Mar. 15, 2012
(86) PCT No.: PCT/EP2012/054539

§ 371 Date: Sep. 11, 2014

(51) Int. Cl. H04W 72/12

(52) U.S. Cl. CPC H04W 72/1268
USPC 370/329

(57) ABSTRACT

Methods and apparatus for controlling scheduling of uplink resources in a system where communication devices can communicate via a multiple of cells are dislosed. Scheduling weight information regarding a primary node and at least one secondary node can be determined and signalled by a node to at least one other node, for example to the at least one secondary node and/or at least one communication device. The received scheduling weight information can then be used in weighting of buffer status information before scheduling of uplink communications.

The application relates to communications over multiple data flows in a communication system and more particularly to multiple data flows in wireless uplink.

A communication system can be seen as a facility that enables communication sessions between two or more nodes such as fixed or mobile communication devices, access points such as base stations, servers and so on. A communication system and compatible communicating entities typically operate in accordance with a given standard or specification which sets out what the various entities associated with the system are permitted to do and how that should be achieved. For example, the standards, specifications and related protocols can define the manner how communication devices shall communicate with the access points, how various aspects of the communications shall be implemented and how the devices shall be configured.

Signals can be carried on wired or wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells, such systems being often referred to as cellular systems. A cell can be provided by a base station, there being various different types of base stations. Different types of cells can provide different features. For example, cells can have different shapes, sizes and other characteristics. A cell is typically controlled by a control node. One control node may control one or more stations providing cells.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station and/or another user equipment. The communication device may access a carrier provided by a base station, and transmit and/or receive communications on the carrier.

An example of cellular communication systems is an architecture that is being standardized by the 3rd Generation Partnership Project (3GPP). A recent development in this field is often referred to as the long-term evolution (LTE) of the Universal Mobile Telecommunications System (UMTS) radio-access technology. In LTE base stations are commonly referred to as enhanced NodeBs (eNB). An eNB can provide coverage for an entire cell or similar radio service area. In LTE a node providing a relatively wide coverage area can be referred to as a macro eNode B. Network nodes can also provide smaller service areas. Examples of such local radio service area network nodes include femto nodes such as Home eNBs (HeNB), pico nodes such as pico eNodeBs (pico-eNB) and remote radio heads. The smaller radio service areas can be located wholly or partially within a larger radio service area.

A device within an area may communicate with more than one cell. Communication with more than one cell can be referred to as multi-flow communications. The scheduling of communications by a device with more than one cell can be challenging in certain scenarios. For example, in accordance with the current proposals multi-flow transmission uplink scheduling actions are delayed in the eNB controlling the primary cell (PCell; master node) while monitoring the uplink traffic scheduled on a secondary cell (SCell; slave node). The uplink packet scheduler associated with the PCell can then determine based on this monitoring whether or not additional resources need to be allocated for the uplink provided by the PCell. In case of multi-flows in the uplink, each eNB can operate independently based on a buffer status report (BSR) received from the relevant communication device. According to another possibility some buffer state information is reported to the other eNB, typically over an X2 interface. The additional uplink capacity that the PCell/master node may need to schedule is determined by comparing the uplink data rate scheduled by the slave node with the uplink buffer state information available at the master node.

These proposals may not always be optimal and/or may have some limitations in view of flexibility and/or efficiency. For example, the slave node may not be aware whether or not the master node is scheduling uplink capacity. The slave node may also not be aware of the uplink resources that are available at the master node. For example, the slave node may not know the average capacity of a PCell. Also, even if some information is exchanged, the mechanism may be relatively slow since if it requires an uplink scheduler of the master node to make measurements of the data throughput scheduled by the slave node. Overall, a solution to control scheduling by the at least two nodes involved may be desired.

It is noted that the above discussed issues are not limited to any particular communication environment and station apparatus but may occur in any appropriate system enabling multiple uplink connections.

Embodiments of the invention aim to address one or several of the above issues.

In accordance with an embodiment there is provided a method for scheduling uplink resources in a node for a system where communication devices can communicate via a multiple of cells, comprising determining scheduling weight information regarding a primary node and at least one secondary node, and signalling the scheduling weight information to at least one other node.

In accordance with an embodiment there is provided a method for communicating buffer status information by a device, comprising receiving scheduling weight information regarding a primary node and at least one secondary node, weighting at least one buffer status report based on the scheduling weight information, and sending the at least one weighted buffer status report.

In accordance with an embodiment there is provided a method for controlling scheduling of uplink resources by a node for a system where communication devices can communicate via a multiple of cells, comprising obtaining scheduling weight information regarding a primary node and at least one secondary node, receiving buffer status information from at least one communication device, and scheduling uplink transmission based on the scheduling weight information and the buffer status information.

In accordance with an embodiment there is provided an apparatus for controlling scheduling of uplink transmissions in a node for a system where communication devices can communicate via a multiple of cells, the apparatus comprising at least one processor, and at least one memory including computer program code, wherein the at least one memory and the computer program code are configured, with the at least one processor, to determine scheduling weight information regarding a primary node and at least one secondary node, and cause signalling of the scheduling weight information to at least one other node.

In accordance with an embodiment there is provided an apparatus for controlling reporting of buffer status information by a device, the apparatus comprising at least one processor, and at least one memory including computer program code, wherein the at least one memory and the computer program code are configured, with the at least one processor, to receive scheduling weight information regarding a primary node and at least one secondary node, weight at least one buffer status report based on the scheduling weight information, and cause sending of the at least one weighted buffer status report.

In accordance with a yet further embodiment there is provided an apparatus for controlling scheduling of uplink resources by a node for a system where communication devices can communicate via a multiple of cells, the apparatus comprising at least one processor, and at least one memory including computer program code, wherein the at least one memory and the computer program code are configured, with the at least one processor, to obtain scheduling weight information regarding a primary node and at least one secondary node, receive buffer status information from at least one communication device, and schedule uplink transmission based on the scheduling weight information and the buffer status information.

In accordance with a more specific embodiment the scheduling weight information is communicated from the primary node to the at least one secondary node and/or at least one communication device.

The scheduling weight information can be provided for weighting buffer status information. The scheduling weight information can be applied to buffer status reports.

Scheduling weight information may be determined on information about the uplink throughput of a cell.

An estimate of an uplink data throughput that is available for scheduling by a node may be provided and used in determining the weight information. Information about estimated uplink data throughput may be exchanged between the primary node and the secondary node.

Buffering status reports may be weighted on a per cell basis and/or on a per communication device basis.

A computer program comprising program code means adapted to perform the herein described methods may also be provided. In accordance with further embodiments apparatus and/or computer program product that can be embodied on a computer readable medium for providing at least one of the above methods is provided.

A node such as a base station or a user equipment, for example a mobile station can be configured to operate in accordance with the various embodiments.

It should be appreciated that any feature of any aspect may be combined with any other feature of any other aspect.

Embodiments will now be described in further detail, by way of example only, with reference to the following examples and accompanying drawings, in which:

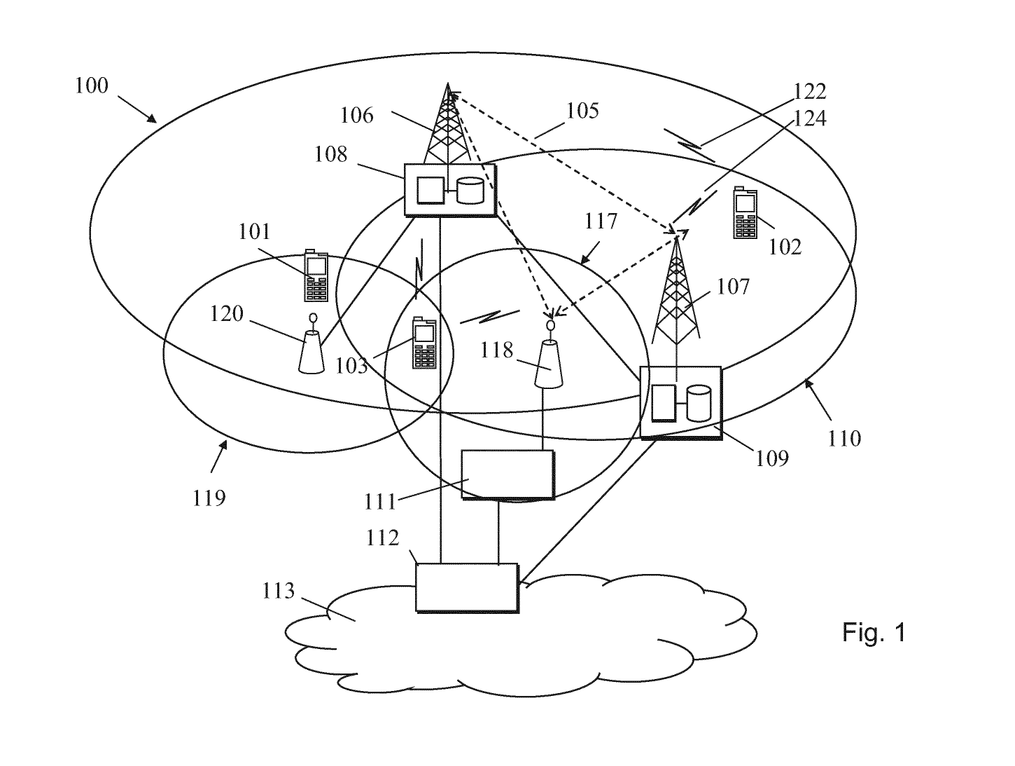

FIG. 1 shows a schematic diagram of a network according to some embodiments;

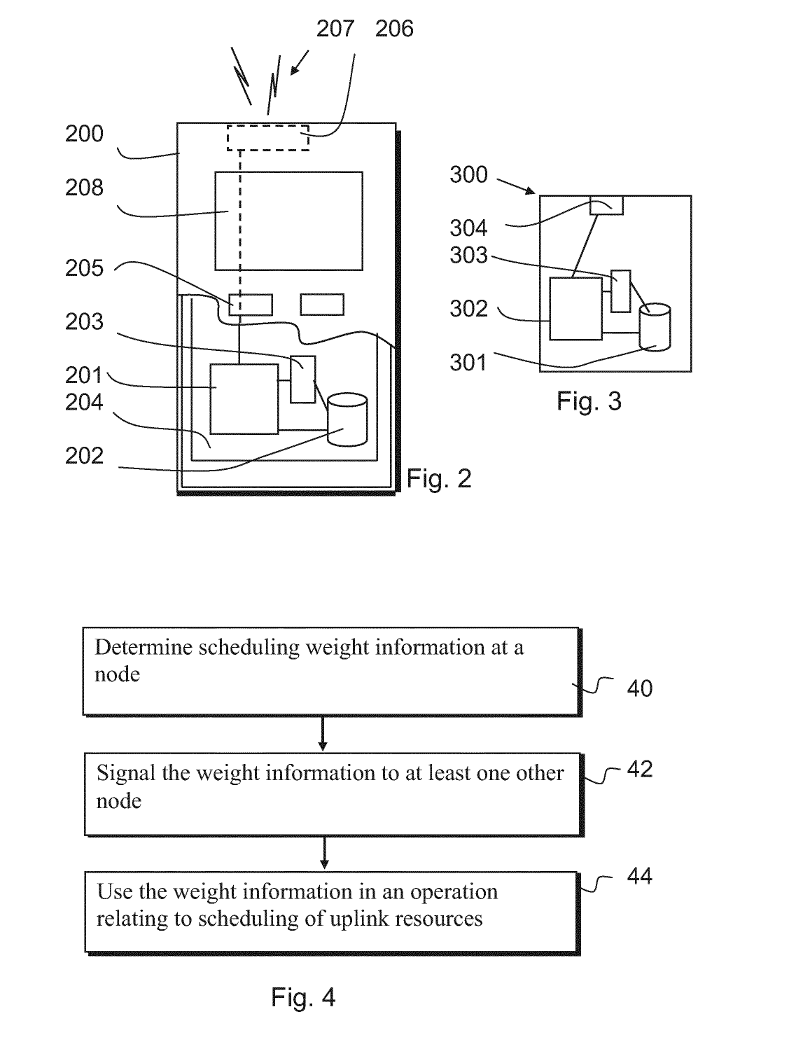

FIG. 2 shows a schematic diagram of a mobile communication device according to some embodiments;

FIG. 3 shows a schematic diagram of a control apparatus according to some embodiments; and

FIGS. 4 to 6 show schematic flowcharts according to certain embodiments.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A non-limiting example of the recent developments in communication system architectures is the long-term evolution (LTE) of the Universal Mobile Telecommunications System (UMTS) that is being standardized by the 3rd Generation Partnership Project (3GPP). The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

A communication device 101, 102, 103 can be provided wireless access via base stations or similar wireless transmitter and/or receiver nodes providing radio service areas or cells. In FIG. 1 different neighbouring and/or overlapping systems or radio service areas 100, 110, 117 and 119 are shown being provided by base stations 105, 106, 118 and 119. It is noted that the cell borders are schematically shown for illustration purposes only in FIG. 1. It shall be understood that the sizes and shapes of the cells or other radio service areas may vary considerably from the similarly sized omni-directional shapes of FIG. 1. A base station site can provide one or more cells or sectors, each sector providing a cell or a subarea of a cell. Each communication device and base station may have one or more radio channels open at the same time and may send signals to and/or receive signals from more than one source

Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some embodiments, each base station can comprise a control apparatus. In alternative embodiments, two or more base stations may share a control apparatus. In some embodiments the control apparatus may be respectively provided in each base station.

Different types of possible cells include those known as macro cells, pico cells and femto cells. For example, transmission/reception points or base stations can comprise wide area network nodes such as a macro eNode B (eNB) which may, for example, provide coverage for an entire cell or similar radio service area. Base station can also be provided by small or local radio service area network nodes, for example Home eNBs (HeNB), pico eNodeBs (pico-eNB), or femto nodes. Some applications utilise radio remote heads (RRH) that are connected to for example an eNB. Cell areas typically overlap, and thus a communication device in an area can listen and transmit to more than one base station. Smaller radio service areas can be located entirely or at least partially within a larger radio service area. A communication device may thus communicate with more than one cell. In some embodiments network nodes can comprise a combination of wide area network nodes and small area network nodes deployed using the same frequency carriers (e.g. co-channel deployment).

In particular, FIG. 1 depicts a primary or master cell 100. In this example the primary cell 100 can be provided by a wide area base station 106 provided by a macro-eNB. The macro-eNB 106 transmits and receives data over the entire coverage of the cell 100. A secondary cell 110 in this example is a pico-cell. A further cell can be provided by a suitable small area network node 118 such as Home eNBs (HeNB) (femto cell) or another pico eNodeBs (pico-eNB). A yet further cell 119 is shown to be provided by a remote radio head (RRH) 120 connected to the base station apparatus of cell 100.

Base station may communicate via each other via fixed line connection and/or air interface. The logical connection between the base station nodes can be provided for example by an X2 interface. In FIG. 1 this interface is shown by the dashed line denoted by 105.

In FIG. 1 stations 106 and 107 are shown as connected to a wider communications network 113 via gateway 112. A further gateway function may be provided to connect to another network. The smaller stations 118 and 120 can also be connected to the network 113, for example by a separate gateway function and/or via the macro level cells. In the example, station 118 is connected via a gateway 111 whilst station 120 connects via the controller apparatus 108.

A possible mobile communication device for transmitting to and receiving from a plurality of base stations will now be described in more detail with reference to FIG. 2 showing a schematic, partially sectioned view of a communication device 200. Such a communication device is often referred to as user equipment (UE) or terminal. An appropriate mobile communication device may be provided by any device capable of sending radio signals to and/or receiving radio signals from multiple cells. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile device may receive and transmit signals over an air interface 207 with multiple base stations via an appropriate transceiver apparatus. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile communication device is also provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a transceiver base station. The control apparatus 300 can be arranged to provide control on communications in the service area of a cell. In some embodiments a base station can comprise a separate control apparatus. In other embodiments the control apparatus can be another network element. The control apparatus 300 can be configured to provide control functions in association with cell aggregation or other multi-flow arrangement by means of the data processing facility in accordance with certain embodiments described below. For this purpose the control apparatus comprises at least one memory 301, at least one data processing unit 302, 303 and an input/output interface 304. Via the interface the control apparatus can be coupled to a receiver and a transmitter of the base station. The control apparatus can be configured to execute an appropriate software code to provide the control functions. It shall be appreciated that similar component can be provided in a control apparatus provided elsewhere in the system for controlling reception of sufficient information for decoding of received information blocks.

A wireless communication device, such as a mobile or base station, can be provided with a Multiple Input/Multiple Output (MIMO) antenna system for enabling multi-flow communications. MIMO arrangements as such are known. MIMO systems use multiple antennas at the transmitter and receiver along with advanced digital signal processing to improve link quality and capacity. More data can be received and/or sent where there are more antennae elements.

A device can receive from and/or transmit to more than one station at a time. Use of multiple flows is utilised e.g.

in techniques known as carrier aggregation (CA) and/or coordinated multipoint (CoMP) transmissions. In carrier aggregation a plurality of component carriers are aggregated to increase bandwidth. An arrangement providing this is X2-based inter-site LTE carrier aggregation (CA)/coordinated multipoint (CoMP). X2 is a logical interface between base stations, for example enhanced NodeBs (eNB) as shown by the dashed lines 105 in FIG. 1.

When configured with inter-site CA/CoMP a communication device/user equipment (UE) can be connected to multiple non-collocated eNBs. In FIG. 1 device 102 is shown to communicate over wireless links 122 and 124 with stations 106 and 107, respectively. Similarly, device 103 is shown to have multiple wireless data flows with nodes 108 and 118. The links can be via separate frequency carriers or on a frequency. eNB 108 can provide a primary access point or node controlling a primary cell (PCell), and possibly one or more secondary cells (SCell). The other eNB(s) 109 involved in the communications can control one or more secondary cells. The current thinking is that data split in the downlink takes place in one of the transmission nodes. Such a node can be referred to as master node, and is typically the node controlling the PCell. That would be node 108 in FIG. 1. Part of the originated data flows is transmitted to the communication device via the master node using one or more carrier frequencies, while the rest of the data flows are forwarded via X2 link 105 to a secondary transmission point 107, often referred to as a slave node, and is then delivered on the downlink from the slave node to the communication device 102 using one or more carrier frequencies. The carrier frequencies used by the slave node are typically other than those used by the master node.

Multi-flow transmission in the uplink (UL) is also possible. This may require that the user equipment (UE) 102 is configured with inter-site CA/CoMP and supports dual-carrier transmission in the UL. Also, the UE 102 can be configured with inter-site CA/CoMP but such that it only supports single-carrier transmission in the uplink (UL). The master-slave (e.g. macro-pico cell) UL switching pattern for such communications can be configured by higher layers. During macrospecific and pico-specific subframes the UE can be scheduled physical uplink shared channel (PUSCH) resources by the corresponding node, i.e. PUSCH is available on both PCell (master node/macro cell) and SCell (slave node/pico cell).

However, the PUSCH resources cannot be scheduled in the same subframe for the master and he slave.

An underlying assumption with the X2-based inter-site CA/CoMP is that each node performs scheduling independently. This can be done at least partially based on buffer status reports (BSR). For example, in LTE Release 10 specifications buffer status reports (BSR) can be transmitted from UEs to any of the available serving cells in the UL. However, a problematic situation can occur in handling of BSRs when there are multiple scheduling nodes in connection with UL multi-flow transmission. There are various proposals how to convey information for uplink scheduling in case of LTE multi-flow transmission in UL. One of these is a scenario where BSRs by the UEs are always transmitted on both PCell and SCell. According to another proposal UE can decide if it transmits BSR on PCell or SCell. According to a possibility this can be configured via radio resource control (RRC). It is also possible to transmit BSR on PCell only. Regardless of where the report is transmitted, a solution might be desired how to control and/or coordinate scheduling for uplink transmissions in the primary and/or secondary cells.

In accordance with an embodiment shown in the flowchart of FIG. 4 scheduling weight information is determined at 40. The weight information is signalled at 42 from a primary (master) node to at least one secondary (slave) node and/or communication device. The scheduling weight information can then be used at 44 by an appropriate node receiving the information. For example, the information may be signalled to the secondary node and/or the communication device and buffer status information can be weighted accordingly in before scheduling decisions are made.

Determination of the scheduling weights at a primary node can be based on information sent by the at least one secondary node to the primary node. The primary node may for example calculate or estimate appropriate scheduling weight(s) based on measured or estimated uplink throughput and/or other relevant information. For example, explicit information about estimated UL capacity may be provided. Alternatively, or additionally the determination may be based on e.g. measurements of the scheduled throughput. Information regarding UL data reception from the secondary node may also be used in here.

Exchange of information between the primary and secondary nodes may be needed in certain embodiments for the calculations/estimations of the weight(s). Examples for this will be given below.

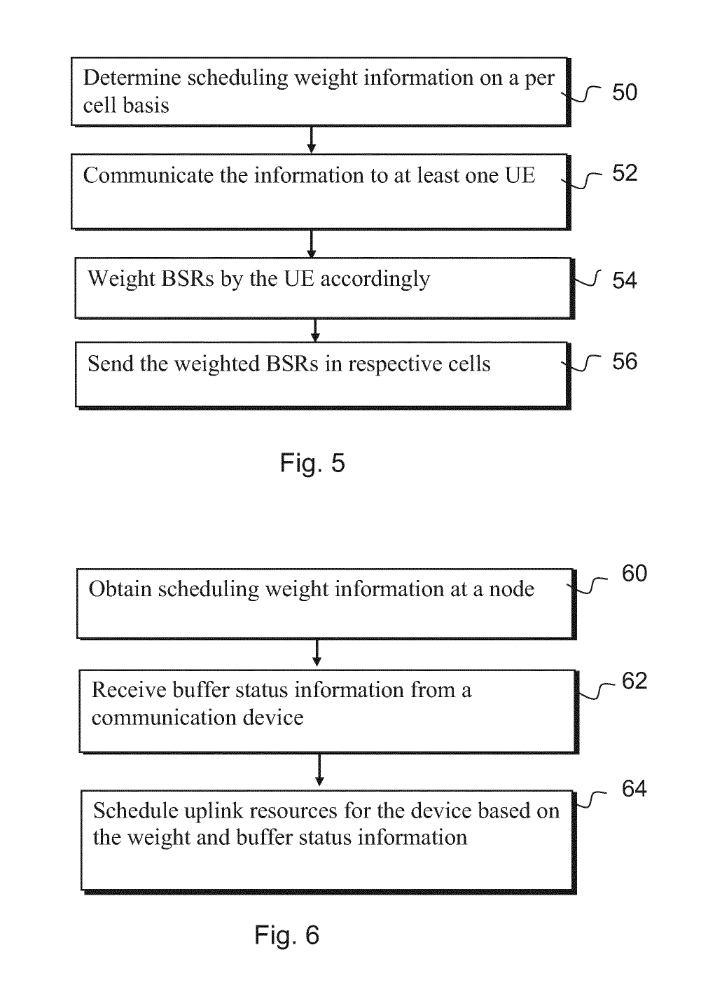

FIG. 5 shows an embodiment where the scheduling weight information is determined at 50 and communicated at 52 to a communication device. The received information is then used at 54 by the communication device. The communication device can apply the weight information to at least one BSR in before transmission thereof to a relevant node at 56.

According to a possibility weights are calculated in a master node and signalled then to relevant UEs. The signalling may be for example via radio resource control (RRC). The UE can then weight the BRS value accordingly before sending BSR towards the corresponding node. The weight may be cell-specific and an UL BSR weighting may be provided in a cell-specific manner. For example PCell-specific BSR can be transmitted on the PCell, etc. For example, the UE can report x % of the buffer status to a PCell and (100-x)% of the buffer status to a SCell where the UL BSR weight x is configured by the master eNB. Also, different UEs with data radio bearers (DRB) with different quality of service (QoS) can have different weights. For example, delay sensitive traffic may be scheduled via PCell while delay tolerant traffic, especially if there is large data amount, may be more suitably scheduled via a SCell. Cell-specific can refer to difference serving cells of a UE such that two cells can have different weights.

It is noted that cell specific this does not mean that all UEs in a cell shall apply the same weight. For example, UE specific weight can also be applied. From UE point of view it does not matter if the weighting is UE specific and/or cell-specific. Instead, a UE can apply a weight to buffer status reporting as received regardless how the weight is defined.

FIG. 6 shows use of scheduling weight information obtained at 60 in a primary and/or secondary node. In a primary node the step of obtaining may comprise the determining step 40 of FIG. 4. In a secondary node the step of obtaining may comprise receiving of the information from a primary node. Buffer status information is received at 62 from at least one communication device. Scheduling of the uplink for the at least one device is then provided at 64 at least in part based on the buffer status information and the weight information.

In accordance with an embodiment the secondary nodes are provided with weight information but no other information such as information regarding the amount of resources scheduled by the primary cell or capacity of the primary cell may be needed.

The weight may or may not have a direct relation with the amount of resources scheduled by the primary node. This can depend on the algorithm used at the primary node to calculate the weights.

In accordance with an embodiment cell-specific uplink buffer status report (UL BSR) weights are calculated in a master node. A pico SCell specific weight can be reported back to the slave node. Then each scheduling node can weigh the reported BSR from the UE according to its specific weight before allocating UL resources on the specific cell.

Cell-specific UL BSR weights can be determined by the master eNB based on various information. For example, estimations of the uplink throughput that can be scheduled by each node can be used as basis of the determination. The estimation of the throughput that can be scheduled at the secondary node can be forwarded to the master node over X2 for the determination of the weights. Information such as an estimation of uplink throughput that can be scheduled by the primary node and measurements of the uplink throughput actually scheduled by the secondary node may also be used in determining the weights. In the latter case all this information can be measured/estimated by the primary node. An advantage of this is that there is no need to forward any information from the secondary nodes.

In accordance with an embodiment secondary nodes schedule uplink resources as much as they can. The primary node of the PCell can estimate the UL capacity of the secondary node/SCell based on UL data it receives, where after it can inform the node of the SCell about the PCell UL capacity and the SCell can adjust its scheduling accordingly if this is considered necessary. As mentioned above, information between primary and secondary nodes may be exchanged. The primary node may send the determined weight information and other information and the secondary node may send information for use in determining the weights. For example, an estimate of uplink data throughput that is available for scheduling of the uplink resources by the secondary node may be provided and the primary and secondary node can exchange information for the generation of the estimate. Data can be exchanged between the nodes over a logical interface between the nodes. For example, X2 interface may be used.

The primary node can receive information of estimated uplink data throughput available for scheduling by at least one secondary node, and can thereafter determine weighting for buffer status information and schedule at uplink resources for at least one communication device based at least in part on the estimate. For example, LTE eNBs can exchange information on the amount of UL throughput they plan to schedule in the future. By making information on the amount of data traffic scheduled by the primary node available at the secondary node overall scheduling efficiency may be improved. The information on the amount of data traffic may be provided in relative or absolute terms.

Use of estimates instead of actual measurements enables operation where the need to wait for the primary or master eNB to perform measurements of the scheduled throughput by the secondary or slave node(s) can be avoided before the slave node can determine the (relative) amount of UL traffic that it needs to schedule.

An estimate of the uplink throughput that can be scheduled at the secondary node for a specific UE can also be calculated based on information such as UL signal to interference plus noise ratio (SINR), configured primary node secondary node UL switching pattern and/or the load conditions in the relevant secondary cell.

It is noted that whilst embodiments have been described in relation to LTE, similar principles can be applied to any other communication system or indeed to further developments with LTE. Also, instead of carriers provided by base stations at least one of the carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for scheduling uplink resources in a node for a system where communication devices can communicate via a multiple of cells, comprising:
determining scheduling weight information regarding a primary node and at least one secondary node, and
signalling the scheduling weight information to at least one other node.

2. A method according to claim 1, comprising signalling the scheduling weight information from the primary node to the at least one secondary node and/or at least one communication device.

3. A method according to claim 1, wherein the scheduling weight information is for weighting buffer status information.

4. A method according to claim 3, comprising applying the scheduling weight information to buffer status reports.

5. A method for communicating buffer status information by a device, comprising:
receiving scheduling weight information regarding a primary node and at least one secondary node,
weighting at least one buffer status report based on the scheduling weight information, and
sending the at least one weighted buffer status report.

6. A method for controlling scheduling of uplink resources by a node for a system where communication devices can communicate via a multiple of cells, comprising:
obtaining scheduling weight information regarding a primary node and at least one secondary node,
receiving buffer status information from at least one communication device, and
scheduling uplink transmission based on the scheduling weight information and the buffer status information.

7. A method according to claim 6, wherein the obtaining of scheduling weight information comprises determining the information in the primary node.

8. A method according to claim 6, wherein the obtaining of scheduling weight information comprises receiving the information from the primary node.

9. A method according to claim 1, comprising determining scheduling weight information for a cell based on information about the uplink throughput of the cell.

10. A method according to claim 6, comprising estimating uplink data throughput that is available for scheduling by a node.

11. A method according to claim 10, comprising exchanging information about the estimated uplink data throughput between the primary node and the secondary node.

12. A method according to claim 6, comprising weighting buffering status reports from communication devices on a per cell basis and/or on a per communication device basis.

13. A method according to claim 6, wherein the weight information is determined based at on at least one of uplink signal to interference plus noise ratio (SINR), a configured uplink switching pattern between the nodes and load conditions in a relevant cell associated with the secondary node.

14. An apparatus for controlling scheduling of uplink transmissions in a node for a system where communication devices can communicate via a multiple of cells, the apparatus comprising at least one processor, and at least one memory including computer program code, wherein the at least one memory and the computer program code are configured, with the at least one processor, to
determine scheduling weight information regarding a primary node and at least one secondary node, and
cause signalling of the scheduling weight information to at least one other node.

15. An apparatus according to claim 14, configured to cause signalling of the scheduling weight information from the primary node to the at least one secondary node and/or at least one communication device.

16. An apparatus according to claim 14, configured to provide the scheduling weight information for weighting of buffer status information.

17. An apparatus according to claim 16, wherein the scheduling weight information is for weighing buffer status reports,

18. An apparatus for controlling reporting of buffer status information by a device, the apparatus comprising at least one processor, and at least one memory including computer program code, wherein the at least one memory and the computer program code are configured, with the at least one processor, to
receive scheduling weight information regarding a primary node and at least one secondary node,
weight at least one buffer status report based on the scheduling weight information, and
cause sending of the at least one weighted buffer status report.

19. An apparatus for controlling scheduling of uplink re-sources by a node for a system where communication devices can communicate via a multiple of cells, the apparatus comprising at least one processor, and at least one memory including computer program code, wherein the at least one memory and the computer program code are configured, with the at least one processor, to
obtain scheduling weight information regarding a primary node and at least one secondary node,
receive buffer status information from at least one communication device, and
schedule uplink transmission based on the scheduling weight information and the buffer status information.

20. An apparatus according to claim 19, configured to obtain the scheduling weight information by determining the information at the primary node.

21. An apparatus according to claim 19, configured to obtain the scheduling weight information by receiving the information from the primary node.

22. An apparatus according to claim 14, comprising determining scheduling weight information for a cell based on information about the uplink throughput of the cell.

23. An apparatus according to claim 14, configured to process estimates of uplink data throughput available for scheduling by a node.

24. An apparatus according to claim 23, configured to cause exchange of information about estimated uplink data throughput between the primary node and the secondary node.

25. An apparatus according to claim 14, configured to weight buffering status reports on a per cell basis and/or per communication device basis.

26. A network node comprising the apparatus of claim 14.

27. A user equipment comprising the apparatus of claim 18.

28. A communication system comprising the apparatus of claim 14.

29. A computer program comprising code means adapted to perform the steps of claim 1 when the program is run on a processor.
